(19) United States
(12) Patent Application Publication
(10) Pub. No.: US 2006/0112797 A1
(43) Pub. Date: Jun. 1, 2006

(54) Universal screw driver blade for recessed cross-slot head screws

(76) Inventor: Frank Zucker, Iserlohn (DE)

Correspondence Address: KLAUS J. BACH & ASSOCIATES;PATENT AND TRADEMARKS, 4407 TWIN OAKS DRIVE, MURRYSVILLE, PA, 15668, US

(21) Appl. No.: 11/274,798

(22) Filed: Nov. 15, 2005

(30) Foreign Application Priority Data
Nov. 30, 2004 (DE) 20 2004 018 498.2

(51) Int. Cl. B25B 15/00; B25B 23/00

(52) U.S. Cl. 81/460; 81/436

(57) ABSTRACT

In a universal cross-slot head screwdriver blade for use with cross-slot head screws of different size ranges the screwdriver has a cross-slot blade with cross ribs which form at the front of the screw driver blade a narrow tip corresponding to the configuration of a small size cross-slot head screw and which extend rearwardly and radially outwardly over a plurality of cross-slot head screw size ranges and which may extend radially even beyond the circumference of a shaft of the cross-slot head screwdriver blade so that the axially rear ends of the cross-slot head screwdriver blade is sized to accommodate a size range substantially larger than the front end of the cross-slot head screwdriver blade.

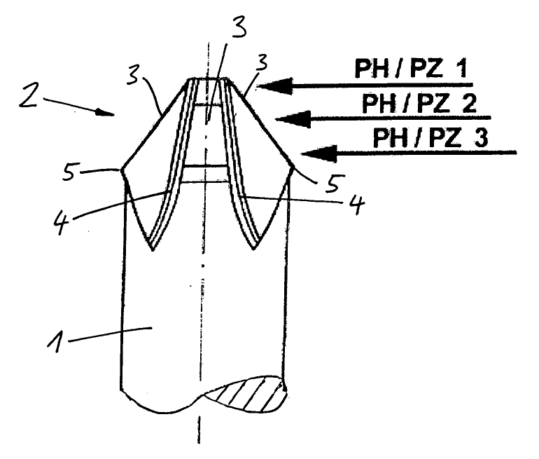

### BACKGROUND OF THE INVENTION

The invention relates to a universal screwdriver blade for recessed cross-slot head screws. Universal in this connection means that a single screw driver blade is usable for a wide size range of recessed cross-slot head screws.

Recessed cross-slot head screws or Phillips head screws include two cross-like slots formed into the screw head which narrow down toward their bottom end. Also, the slot edges converge downwardly in an arrow-like fashion. In accordance therewith a cross-slot head or Phillips screwdriver blade has a complementary shape with four rectangularly arranged ribs which narrow down toward the tip in an arrow-like fashion.

Philips head screws have different head sizes depending on the diameter of the screws. For different head sizes also the conventional Phillips screwdriver head blades are shaped differently. With a small screwdriver blade, it is impossible to transmit sufficient torque to a large screw and a large screwdriver blade cannot be inserted into the cross-slot of a small screw.

As a result, it is necessary in practice to have an assortment of screwdrivers of different sizes available which has several disadvantages. For one, it is annoying to carry a whole assortment of screwdrivers along in the trouser- or coat pockets if one has to work with different-size screws. Furthermore, as is well-known just the exact size screw driver needed for a particular screw is generally missing and, with the use of a screw driver with exchangeable bits such a bit exchange is inconvenient and the bits are often lost.

It is therefore the object of the present invention to provide a universally usable screw driver blade for Phillips screws of different sizes.

### SUMMARY OF THE INVENTION

In a universal cross-slot head screwdriver blade for use with cross-slot head screws of different size ranges the screwdriver has a cross-slot blade with cross ribs which form at the front of the screw driver blade a narrow tip corresponding to the configuration of a small size cross-slot head screw and which extend rearwardly and radially outwardly over a plurality of cross-slot head screw size ranges and which may extend radially even beyond the circumference of a shaft of the cross-slot head screwdriver blade so that the axially rear ends of the cross-slot head screwdriver blade is sized to accommodate a size range substantially larger than the front end of the cross-slot head screwdriver blade.

The invention is of course usable in connection with screw driver blades of conventional screw drivers and also with screwdriver bits which can be inserted into screw driver bit holders.

The invention will be described in greater detail below with reference to the accompanying drawings.

### BRIEF DESCRIPTION OF THE DRAWING

The sole FIGURE is an enlarged side view of a universal Phillips head screwdriver blade.

### DESCRIPTION OF A PREFERRED EMBODIMENT

The property “universal”, that is, the possible use of the screwdriver in connection with screws in a wide range of sizes is achieved by the geometric contour of the screw driver blade.

The FIGURE shows a cross-slot or Phillips screwdriver blade 2 disposed at the end of a shaft 1 in such a view that of the four cross ribs 3, one (in the center) is shown along its edge area and of the two adjacent ribs, the side surfaces are seen. The fourth rib is not visible. The inner corners between the adjacent ribs 3 are designated by the reference numeral 4.

In comparison with conventional Phillips head screwdriver blades, the ribs 3 have a substantially increased length and a thin pointed tip, (which however is shown in the enlarged representation relatively obtuse) from which the ribs 3 extend up to a relatively large shaft diameter of the shaft 1. As shown in the FIGURE, the axially rear rib ends 5 may extend radially beyond the outer circumference of the shaft 1 so that they project therefrom. The extension of the projection is shown in the FIGURE to be only relatively small, but it could be made to be substantially larger. With this feature, the shaft diameter does not need to be as large as the tip but can be kept to a relatively small diameter. The screwdriver blade is formed at its front end for very small screws, but widens axially rearwardly to a size suitable for the engagement of substantially larger screws.

In the exemplary embodiment shown in the FIGURE, the Phillips screw driver blade encompasses three conventional size ranges as indicated by the arrows shown at the right side of the FIGURE which indicate the range of the Phillips screwdriver blade, which is effective for the respective screw head size. As indicated, the shown Phillips screwdriver blade encompasses three size ranges. It is noted, that the invention may also cover screwdriver blades, which accommodate more than three size ranges.

The size designations at the arrows in the drawing are abbreviations for the commercially available two cross-slot recessed head screwdriver systems designated PH and PZ. The thickness of the ribs 3 is so selected that it corresponds to the open width of the cross slots of the system with the smaller slot width so that the screwdriver blade can be used in connection with screws of the PH system as well as with screws of the PZ system. It is to be understood of course that the screwdriver blades may be designed also for use with only one of the two systems in order to provide for an accurate fit so that for the system with the largest slot width a better fit for firm engagement can be obtained.

What is claimed is:

1. A universal cross-slot head screwdriver blade for use with cross-slot head screws of different size ranges, said cross-slot head screw driver blade (2) having cross-ribs (3) forming at the front end of the screwdriver blade a narrow tip corresponding to the cross-slot configuration of a small size cross-slot head screw and extending rearwardly and radially outwardly over a plurality of size ranges of cross-slot head screws so that the axially rear ends (5) of the cross-slot head screwdriver blade is sized to accommodate a cross-slot head screw size range larger than the front end of the cross-slot head screwdriver blade.

2. A universal screwdriver blade according to claim 1, wherein the rear ends (5) of the cross-ribs (3) extend radially beyond the circumference of a shaft (1) of the cross slot head screwdriver blade.
